(19) United States
(12) Patent Application Publication
(10) Pub. No.: US 2009/0207465 A1
(43) Pub. Date: Aug. 20, 2009

(54) Multiple Security Means Comprising an Interactive Security Element

(76) Inventors: Rodney Riddle, Dorset (GB); Michael Weiden, Darmstadt (DE)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 12/225,458

(22) PCT Filed: Oct. 4, 2006
(86) PCT No.: PCT/EP2006/009576

§ 371 Date: Dec. 16, 2008

(30) Foreign Application Priority Data
Oct. 11, 2005 (EP) 05 022 077.1

(51) Int. Cl. B44F 1/12

(52) U.S. Cl. 359/2

(57) ABSTRACT

The present invention relates to a multiple security means comprising at least one interactive security element and at least one further second security element, wherein the interactive security element comprises at least one volume hologram being responsive to at least one applied external stimulus, the use of said security means as well as to products which contain same.

The present invention relates to a multiple security means comprising at least one interactive security element and at least one further second security element, wherein the interactive security element comprises at least one volume hologram being responsive to at least one applied external stimulus, the use thereof as well as to products which contain said security means.

Preferably, the interactive security means exhibits at least one optical effect which is in the form of an image which is different when being observed at different angles of view, at least after the external stimulus has been applied.

The multiple security means of the present invention is particularly useful for verification, identification, authentication or anti-counterfeiting purposes and may preferably be applied as a public feature to any known product which has to be secured, in particular as brand protection or to security products such as banknotes, passports, identification documents, tickets, credit cards, smart cards etc.

Diffractive elements such as embossed holograms have widespread use as protective features in the security and brand protection industry. When being used as public features, the level of security and protection which these elements provide is limited. Whereas a person skilled in the art who deals with development and/or verification of security elements may be in a position to differ between original and counterfeited products, the so called “person in the street” may not be aware of the slight differences exhibited by holograms used in counterfeited products, even not in a direct comparison with the original product. Furthermore, the standard type of security holograms in current use may now be copied and easily made in large quantities using commercial equipment that is readily available.

Since typical holograms exhibit the disadvantages mentioned above, they are currently often used in combination with one or more further security elements on security products to render the latter more secure. Many of such further security elements are traditionally used in security products and should be integrated in novel security products too, e.g. water marks or security threads in banknotes, photographs bearing non-visible but detectable taggants in ID-cards etc. Of course, those traditionally used security elements should be used in combination with new developed security features without impairing the function of the new developed security features and without being impaired by said features themselves.

Typical kinds of holograms which have been used heretofore in the security industry are thin holograms and surface holograms which are easy to produce and provide impressive optical effects but show, nevertheless, the disadvantages mentioned above.

Although not in common use nowadays, volume holograms have also already been used in the security industry.

EP 0 466 118 A2 discloses a multilayered optical variable element, preferably a hologram, which comprises a stable and thin covering layer, making the transfer of the hologram to a substrate easy. The multilayer structure may contain an embossed and metallized hologram or a volume hologram. The volume hologram is harder to copy than the embossed hologram, but shows no optical effects which are different from those of the embossed hologram. Therefore, it may not easily be evaluated by the general public.

A process for forming a multicolour volume phase hologram in a substantially solid, transparent, photosensitive film element is described in EP 0 529 459 A1. The recording of the volume hologram is done image wise in order to obtain a multicoloured hologram which may be used, amongst others, in security applications. Such volume holograms are multicoloured when viewed at one single angle of view. Therefore, their optical impression is better than that of monocoloured holograms. Additionally, their resistance to copying is improved. Nevertheless, it is difficult for the public to distinguish between original and copy, if there is not a genuine original available for comparison.

EP 1 217 469 A2 discloses a method for producing a holographic optical element comprising primary and complementary holograms. The holographic optical element contains a volume hologram, is useful as a security device and is advantageous since it exhibits two different colours when being tilted. These holographic elements are relatively easy to produce and are almost impossible to copy. When used as a public feature, a direct comparison between original and copy seems still to be necessary in order to evaluate the validity of the hologram.

In EP 0 919 961 B1 a security element for documents is described, which includes a volume hologram showing a kinetic effect and wherein local areas of the volume hologram are shrunk or swollen after the recording of the volume hologram, so that the Bragg network planes in these regions are correspondingly changed. Due to these partially shrunk or swollen areas of the volume hologram, which might not be recognised by an observer, an additional anti-copying effect can be achieved. Thus, only parts of the hologram, if any, can be copied.

Volume holograms showing a kinetic effect are not easily produced and the shrinking or swelling of defined parts of the Bragg network planes, which follows, makes the production process even more complicated.

WO 03/099581 discloses a security element being composed of a surface hologram in combination with a volume hologram. In order to enhance the resistance to copying, the volume hologram may slightly be shrunk or swollen at several parts, leading to interference effects (moiré) within the hologram.

Such combinations of different kinds of holograms cannot easily be produced, in particular when both holograms shall bear the same image. Furthermore, when the original is missing, it is questionable whether the public may recognise a copy due to the moiré effect.

A general overview regarding the technical background with respect to the use of holograms in security applications can be found in “Optical Document Security” by Rudolf L. van Renesse (Editor) Artech House Boston-London, Second Edition 1998, ISBN 0-89006-982-4, chapters 4.4 (holography), 10 (document protection by holograms) and 11 (document protection by optically variable graphics (kinegrams)).

Although holograms have widespread use as security devices, there remains a demand for security holograms which are easy to produce, can only be copied with great difficulty, show outstanding optical effects, may easily be evaluated with respect to their validity, especially by the general public, the so called “person in the street”, and are usable as a multifunctional security means in combination with usually used security features without any hindrance of the effects of both.

It has, therefore, been the object of the present invention to provide a security means containing a hologram which may be produced in a relatively easy process at low cost, may be copied only with great difficulty, exhibits outstanding optical effects and can be used as an easily recognisable public feature which can be evaluated with respect to validity without the need of having an original specimen for comparison and preferably without additional helping means and containing at least one further security element which will not be impaired by the action of the hologram.

A further object of the present invention has been to provide the use of such a security means.

Additionally, it has been another object of the present invention to provide a product which contains said security means.

The object of the present invention is resolved by a multiple security means comprising at least one interactive security element and at least one further second security element, wherein the interactive security element comprises at least one volume hologram, the volume hologram being responsive to at least one applied external stimulus and exhibiting a defined optical effect in the form of an image, at least after the application of said at least one external stimulus to the volume hologram.

Preferably, the multiple security element comprises an interactive security element wherein the optical effect exhibited by the volume hologram in the form of an image may be observed by using an optical detector at a first viewing angle and wherein a second image which is different from the first image may be observed using an optical detector at a second viewing angle which is different from the first viewing angle.

Furthermore, the object of the present invention is resolved by providing the use of the security means according to the invention for verification and/or identification and/or authentication and/or anti-counterfeiting purposes, especially of a product.

Still furthermore, the object of the present invention is resolved by providing a product, containing a multiple security means according to the present invention.

In a first embodiment, which represents the simplest case, the multiple security means of the present invention is composed of a further second security element which is located within an interactive security element, i. e. which is located within at least one volume hologram which the interactive security element comprises.

The further second security element may be disposed throughout the whole volume of the volume hologram or throughout a part of the volume of the volume hologram.

Further second security elements which are usable for this purpose comprise a particulate and/or dissolved material such as one or more of planchettes, fibers, fluorescent particles or fibers, IR or UV active colorants, magnetic particles, electrically conductive particles, optically variable pigments, LCP pigments, DNA- and/or Bio-coding materials, organic or inorganic taggants, or laser engravings etc.

Despite the enclosure of those particulate and/or dissolved materials, the interactive security element being part of the multiple security means of the present invention is not hindered to being responsive to an external stimulus and to exhibit the defined optical effect as described in detail hereunder.

In general, security elements which are used for verification and/or identification and/or authentication and/or anti-counterfeiting purposes, are usually applied into and/or onto a substrate.

As substrates, common materials such as paper, plastic or several kinds of laminates are used.

Similarly, the multiple security means of the present invention comprises a substrate.

Typical substrates are transparent or opaque, flexible, semi-rigid or rigid and may be of glass, plastic, paper, fibrous materials or metals and have a planar surface or any appropriate shaped surface. The choice of an appropriate substrate depends on the kind of the interactive security element and of the further second security elements and how they are applied to the common substrate.

In particular, substrates may be composed of paper of any kind, paper board, plastics, in particular polymers, laminates of paper and plastics, optionally containing both materials in combination, laminates of paper and plastics with other appropriate materials such as metal or wood. Preferred substrates are of paper and/or plastics, optionally at least partly coated with a thin metallic layer.

In a second embodiment of the present invention, the multiple security means of the present invention is composed of a common substrate, containing at least one interactive security element as described later and at least one further second security element which will also be described later.

The interactive security element, being one component of the multiple security means of the present invention, may be applied onto and/or into said common substrate in the form of a label and/or a patch and/or a stripe and/or a thread and/or a window. Therefore, it will usually be visible from at least one surface of the common substrate and/or will in most cases constitute a part of the visible surface of said common substrate.

Thereby, the method how the interactive security element is applied to the common substrate does not play a particular role. Any kind of applying such a security element to a substrate, in particular all kinds of generally known adhesion and laminating techniques will be appropriate. In particular, several methods using adhesives are preferred.

The further second security element, which is contained in the common substrate too, may be applied thereto by different ways.

The first way is the embodiment where the further second security element is disposed throughout the whole volume of the common substrate or throughout a part of the volume of said substrate.

To this end, particular second security elements are used, which may be disposed throughout the volume of, e.g., a paper substrate, a plastic substrate or a laminate of two or more of one of these materials as well as of mixtures of these.

Such security elements have to be either soluble or particulate materials which may be distributed in the raw materials of the substrates used or are security elements which may be accomplished by or after producing the substrates.

Examples for further second security elements which may be disposed in the volume of the substrate are one or more of water marks, laser engravings, planchettes (tiny layered particles being composed of different materials and being detectable due to their particular material composition, colour(s), etc.); fibers, especially of particular detectable materials, e.g. luminescent fibers; fluorescent particles or fibers; IR (infra red) or UV (ultra violet) active colorants; magnetic particles; electrically conductive particles; optically variable pigments; chemical additives which are observable by irradiation with light of particular wavelengths or by chemical reaction or by manipulation of the substrate; DNA- and/or Bio-coding materials; organic or inorganic taggants, etc.

The second way is the embodiment where the further second security element is applied onto and/or into a common substrate in the form of a printing and/or an optical system and/or a label and/or a patch and/or a stripe and/or a thread and/or a window.

Here too, the method of applying the further second security element does not play a particular role. In particular all kinds of generally known adhesion and laminating techniques will be appropriate. Methods using adhesives are preferred.

To this end, the further second security element is one or more of a hologram, a kinegram, a laser engraving, an RFID element, an optically variable printing and/or an optically variable system of optically variable pigments, optically variable thin film structure and/or liquid crystal polymers, a microtext, guilloches, a magnetic feature, an electrically conductive feature, an IR or UV active feature, a photoluminescent feature, an electroluminescent feature, a photochromic feature, a thermochromic feature, a hydrochromic feature, a tribochromic feature, a piezochromic feature, a DNA- and/or Bio-coding feature, etc.

Such further security elements, either disposed in the volume of a substrate or applied onto and/or into the substrate as described above are known per se. In the present invention, they are used as usual, but in combination with the interactive security element described hereunder in order to achieve the multiple security means of the present invention.

The further second security element exhibits the characteristics known, e.g. visible and/or invisible but machine readable or otherwise detectable action.

In a preferred embodiment, the further second security element is detectable by the naked eye and is, therefore, applicable as a visible public feature.

In a further, also preferred embodiment, the further second security element is detectable by the naked eye assisted by spectacles, magnifying lenses, microscopes, lenticular lenses, polarizing filters, diffractive structures, wavelength filter elements or light enhancing systems, spectrophotometers, spectrum analyzers, CCD-sensors, CMOS-sensors, OCR-readers, bar code readers, cameras and/or image recognisers.

In the latter case, the further security element is preferably detectable by specialists in the art only.

The interactive security element and the further second security element may be applied to the common substrate in different spatial ways.

In the first way, both security elements may be applied to the common substrate in a spaced apart manner. In this case, both security elements do not touch each other. For example, the interactive security element may be applied as a label to one half of the common substrate, whereas fluorescent fibers are distributed throughout the volume of a part of the second half of the substrate which is not adjacent to the label. Various further examples may be imagined, applying the security elements mentioned above.

In the second way, both security elements may be applied to the common substrate in an adjacent or partially overlapping or totally overlapping manner. In this case, both security elements touch each other. Taking the example mentioned above, the label constituting the interactive security element of the multiple security means is applied e.g. onto one half of the common substrate in such a way that it covers this half totally, and fluorescent fibers are distributed throughout the second half of the common substrate (both elements being adjacent); the further variant where the fluorescent fibers are distributed as mentioned above, but the label is applied in the middle of the common substrate, thus covering part of the first half without fluorescent particles and part of the second half containing fluorescent particles; the still further variant wherein the label constituting the interactive security element is as big as a half of the common substrate and does totally cover the half of said substrate, wherein the fluorescent fibers are distributed.

Of course, taking the different kinds of security elements mentioned above as well as different parts of the common substrate having different shapes will lead to a great variety of spatial combinations of the interactive security element and the further second security element being applied to a common substrate.

In the third way, the interactive security element and the further security element are applied to a common substrate one on top of the other. In this case, both security elements overlap, whereby the area covered by one element is always bigger than the area covered by the other element, so that one of the elements is totally covered by the other, but not vice versa. For example, an interactive security element covering half of the area of the common substrate is applied onto the common substrate, whereas fluorescent fibers are distributed throughout the volume of the whole common substrate. In a further example, only one half of the volume of the common substrate contains fluorescent fibers, whereas the whole surface of the common substrate is covered by an interactive security element. Of course, many further variations may be imagined, applying the different examples for the further security element mentioned above as well as different possible shapes and sizes of the interactive security element as well as of the further security element.

In a third embodiment of the present invention, the multiple security element of the present invention is composed of a layered structure comprising two or more substrate layers adherent to each other and the interactive security element and the further second security element are applied to different substrate layers of said layered structure, thereby being located apart from each other or adjacent to each other or partly or totally overlapping each other when the security means is virtually viewed from either one of the top and bottom surface thereof.

The number and kind of the two or more substrate layers in the layered structure is not limited. Preferably, two to five layers are used in the layered structure, resulting in a thin security means which may be used in a comfortable manner. The substrate layers may be of the same or of different materials. To this end, those substrate materials mentioned above may be used.

All or part of the substrate layers may bear security elements, as long as at least one first substrate layer contains at least one interactive security element according to the present invention and at least one second substrate layer being different from the first substrate layer contains at least one further security element. Of course, two or more interactive security elements of the same or different types may be applied to the first substrate layer and any of the further substrate layers except the substrate layer which contains the at least one interactive security element may contain more than one security element of the same or of different kinds.

In the layered structure, the interactive security element and the further security element which are applied to different substrate layers of which the layered structure is composed are located apart from each other or adjacent to each other or partly or totally overlapping each other when the security means is virtually viewed from either one of the top and bottom surface thereof.

Thus, concerning the spatial location of the interactive security element and the further security element, similar examples as mentioned above with respect to the first embodiment may be imagined, except that the interactive security element and the further security element are applied to different layers of a layered structure instead of being applied to a common substrate.

For illustration, it can be imagined that said layered structure is a flat structure being composed of two or more flat layers adherent to each other by forming a layered system, e.g. in form of a laminate structure or something similar. Those layered structures have a top and a bottom surface and are in most cases so thin, that the side surfaces do not play an important role.

If one imagines that all substrate layers of such a layered structure were transparent, one could virtually see all security elements which are applied to either of these substrate layers.

Thus, the interactive security element and the further security element can be “seen” as being located apart from each other or adjacent to each other or partly or totally overlapping each other, when being virtually viewed from the top surface and/or the bottom surface of the layered structure.

In a fourth embodiment of the present invention, the first, second and third embodiments are combined in such a way, that the multiple security means of the present invention is composed of a layered structure comprising two or more substrate layers, the interactive security element and at least one further second security element being applied to a common substrate layer, whereas one or more of the other layers of the layered structure comprise one or more further security elements and/or one or more interactive security elements and/or where the interactive security element itself may comprise the further second security element. The spatial location of the different security elements within a substrate layer and/or between different substrate layers is not determined in this case, except that the spatial application of the interactive security element and the further second security element in the substrate layer which constitutes said common substrate is executed as described with respect to embodiment 2.

In the third and fourth embodiment, the interactive security element, as in the first and second embodiment, may be applied onto and/or into the substrate which contains the interactive security element in the form of a label and/or a patch and/or a stripe and/or a thread and/or a window. Like in the first and second embodiment, it will usually be visible or otherwise detectable from at least one outer surface of the layered structure constituting the security means according to the present invention.

In order to summarize the localization of the further second security element in the multiple security means according to the present invention as described in embodiments 1 to 4 above, the further second security element may be disposed throughout the whole volume or a part thereof of the interactive security element, throughout the whole volume or a part thereof of a common substrate or throughout the whole volume or part thereof of a substrate which is part of a layered structure of which the security means is composed, or is an intrinsic part of any of such substrate.

Furthermore, the further second security element may be applied onto and/or into a common substrate or to a substrate which is part of a layered structure of which the security means is composed in the form of a printing and/or an optical system and/or a label and/or a patch and/or a stripe and/or a thread and/or a window.

Details thereto have been described above.

In each of the four embodiments it is preferred that at least one of the interactive security element and the further security element regardless of the spatial location thereof may be detectable by the naked eye itself or by the naked eye assisted by spectacles, magnifying lenses, microscopes, lenticular lenses, polarizing filters, diffractive structures, wavelength filter elements or light enhancing systems, spectrophotometers, spectrum analyzers, CCD-sensors, CMOS-sensors, OCR-readers, bar code readers, cameras and/or image recognisers.

The interactive security element and the further security element of the present invention may either interact with each other or do not interact with each other.

The degree of interaction depends at most on the spatial distance of both and/or on the kind of the further security element. It goes without saying that the shorter the spatial distance between the security elements is, the higher is the possibility of interaction between them.

This kind of interaction has nothing to do with the interaction of the security element with an applied external stimulus, but may take place in the form of partly or totally enhancing, altering or weakening the optical effect of the interactive security element by the influence of the further security element, in the form of simple overlapping of the different detectable effects of both security elements or in a temporary or local deletion of the optical effect of the interactive security element by the action of the further second security element.

The interactive security element being part of the multiple security element of the present invention comprises at least one volume hologram which is responsive to at least one applied external stimulus and exhibits a defined optical effect in the form of an image, at least after the application of said at least one external stimulus to the volume hologram.

Preferably, said optical effect in the form of an image exhibited by the volume hologram may be observed by using an optical detector at a first viewing angle and wherein a second image which is different from the first image may be observed using an optical detector at a second viewing angle which is different from the first viewing angle.

For the purposes of this invention, the term “viewing angle” means an angle of view which the optical detector (naked eye of a person or naked eye assisted by several means as described hereunder) occupies relative to the multiple security means of the present invention. The first and second viewing angles, respectively, are no particular angles, but angles from which the security means may conveniently be observed by the optical detector. The second viewing angle is merely different from the first viewing angle and is, in most cases, achieved by simply tilting the multiple security means or by otherwise altering its relative position to the optical detector, e.g. by moving the multiple security means up and down, moving the optical detector etc.

In order to be useful as a valuable public feature, a hologram must exhibit outstanding optical effects which may easily be recognised by the so called “person in the street” and preferably, the validity of such a hologram must be recognisable immediately, preferably without the help of additional means which are not usually carried by any person. Furthermore, considering identity cards, credit cards, driving licenses or even bank notes, it is unlikely that a person who wants to check the validity of such a document will always have an original document for comparison in hand. Therefore, it must be possible to check the validity of such a document without a comparison sample.

The interactive security element of the present invention fulfils these requirements in an outstanding manner, because it is responsive to at least one applied external stimulus and it shows an optical effect in the form of an image, which may be observed at least after the stimulus has been applied.

In the simplest form, the external stimulus is at least one of humidity, water, temperature, pressure or light. Most of these stimuli can be readily provided by the “person in the street”, for example by his breath, body temperature, rubbing or pressure of a finger, different light sources, some drops of water, etc. Furthermore, in a preferred embodiment, an optical detector which is used when checking the security element is the naked eye. At least after one of the external stimuli mentioned above has been applied to the interactive security element, a defined optical effect in form of an image may be observed. Therefore, an immediate check of the validity of a security product comprising the multiple security means of the present invention containing the interactive security element is possible by anybody.

The interactive security element being part of the multiple security means of the present invention comprises a volume hologram which is responsive to at least one applied external stimulus and exhibits a defined optical effect in the form of an image. For the purposes of this invention, “responsive” means that the volume hologram interacts with the external stimulus to such an extent that an image which is observable when the multiple security means is illuminated alters after the application of the external stimulus or that no image may be observable prior to the application of an external stimulus whereas after the application of an external stimulus an image is observable, or a combination of both.

In general, at least one of the following is applied as an external stimulus: humidity, water, gases, vapours, organic solvents, chemicals, solutions or dispersions of chemicals, pressure, temperature, light of particular wave-lengths, magnetism, electrical field, electrical charge, electrical potential, non-ionising radiation, electromagnetic radiation, radioactive radiation, enzymes, biological materials and combinations of two or more thereof. All these stimuli may also vary in degree or intensity, irrespective of whether being used singly or in combination.

Of course, not all of these stimuli are available to everyone at all times. Therefore, to a certain extent, at least in some embodiments, the interactive security element of the present invention will not be recognisable in all aspects by everybody. Thus, a combination of several stimuli causing different images will enhance the degree of security of the multiple security means of the present invention, in particular when some of these stimuli may only be applied by a person skilled in the art.

It has been mentioned before that the validity of the interactive security element according to the present invention must be immediately recognisable when being used as a valued public feature. Thus, the reaction time of the volume hologram to an applied external stimulus must be very short. In general, the reaction time of the volume hologram after the external stimulus has been applied is between one tenth of a second and several seconds, in particular from 0.1 to 10 seconds.

Preferred are external stimuli like humidity, water, solutions or dispersions of chemicals, pressure, temperature and light of particular wavelengths, in particular humidity, water, or combinations of temperature with pressure or light.

The interactive security element according to the present invention exhibits a defined optical effect in the form of an image. For the purpose of the present invention, the term “image” is defined as being a holographic representation of an object.

Such an object may comprise, but is not limited to, a mirror, a reflective surface, an alphanumeric or other character, a microtext, a picture, a photo, a bar code, a physical object, a logo, a trade mark, a computer generated picture, a computer generated object and projections thereof. It goes without saying that one or more of these objects may be used in combination.

For the purpose of this invention, the term “alphanumeric or other character” means any character which is used worldwide to provide written information such as singular characters, words, sentences, descriptions, pictograms, numbers, mathematical relations etc., including Latin, Arabic, Chinese, Japanese, Korean or similar characters.

In a particularly preferred embodiment, the image which is exhibited by the interactive security element may be observed by using an optical detector at a first viewing angle and at a second viewing angle a second different image, which differs from the first image, may be observed, when another optical detector is used, being of the same or of a different kind as the first optical detector. The second viewing angle may be achieved, for example, by tilting or otherwise changing the position of the security means containing the interactive security element relative to the observing unit, whereas the viewing position of the observing unit is maintained or by changing the viewing position of the observing unit, whereas the position of the security means is maintained. Of course, both the viewing position of the observing unit as well as the position of the security means may be changed, but in the latter case it will be difficult to detect whether the viewing angle has indeed been changed.

Additionally, one or more further images may be observed at one or more further viewing angles being different from the first and second viewing angles. These further images may be revealed by simply moving the interactive security element of the present invention using any kind of possible movement, e.g. up and down movement, circular movement or any other movement relative to the observing unit, by movement of the observing unit or by movement of the light source. The further images which may be observed at these further viewing angles are due to the action of the volume hologram itself, since it is possible to record a number of images in a volume hologram regardless of whether it is responsive to stimuli or not. Preferably, such further images may be observed prior to the application of any stimulus. For the purposes of the invention, merely the behaviour of the images which may be observed under the first and second viewing angles shall be described in detail, in order to explain the present invention in a clear and reasonable manner.

For the purpose of this invention, the term “observing unit” is meant to be a person or an optoelectronic verification appliance, e.g. a camera system or a hand-held optical detector described below.

For the purpose of this invention, the term “different image” means, that the images which may be observed at said first and/or second viewing angle are different in colour and/or intensity and/or brightness and/or object

and/or position and/or orientation and/or size and/or apparent depth and/or perspective and/or parallax. Therefore, not only holographic representations of different objects, e. g. bar-codes, logos, trade marks, etc. are regarded being different images, but also for instance a particular logo, which alters in colour, the intensity of the colour, its brightness, its size, its apparent depth and/or its position on the interactive security element, due to the application of at least one external stimulus.

Of course, the definition of the “different image” does also apply for the additional images which may be observed at the further viewing angles which are different from the first and second viewing angles.

An “optical detector” in the sense of the present invention is in the simplest form the naked eye, or the naked eye assisted by spectacles, magnifying lenses, microscopes, lenticular lenses, polarizing filters, diffractive structures, wavelength filter elements or light enhancing systems. Further optical detectors may be, but are not limited to spectrophotometers, spectrum analysers, CCD-sensors, CMOS-sensors, OCR-readers, bar code readers, cameras and image recognisers. Of course, these optical detectors may be used singly or in combination of two or more of them, depending on the kind of image which has to be observed.

The image which may be observed at the first viewing angle and a second different image at a second viewing angle may be observed either prior to the application of at least one external stimulus or after the application of an external stimulus or in both cases.

Thus, the following cases have to be borne in mind:

A first case, wherein prior to the application of an external stimulus no image may be observed at a first and a second viewing angle, respectively, and after the application of an external stimulus a first image may be observed at said first viewing angle and a second image may be observed at said second viewing angle, using a further optical detector, whereby the second image differs from the first image.

Thereby, the second viewing angle, which is different from the first viewing angle, has been achieved by tilting the security means containing the interactive security element whereas the viewing position of the observing unit is maintained or by changing the viewing position of the observing unit, whereas the position of the security means is maintained.

For illustration, one can imagine a security means which does not show any image on the part thereof which is composed of the interactive security element and as soon as an external stimulus, e. g. some drops of water, have been applied, the interactive security element part of the security means exhibits an image in the form of, e.g., a logo at one first viewing angle and after the security means has been tilted or after the observing unit, e.g. a person, has changed its viewing position, the logo image differs from the first in colour, intensity of the colour, its brightness, its size, its orientation, its apparent depth, its perspective, its parallax and/or its position on the interactive security element, or a different logo or a picture may be observed at said second viewing angle.

A second case, wherein on the interactive security part of the security means prior to the application of an external stimulus a first and a second different image may be observed at a first and a second viewing angle, respectively, and after the application of an external stimulus a third image is revealed which may also be observed at said first viewing angle. In this case, the third image is different from the first image and both images may be observed at the same viewing angle, the first image prior to the application of an external stimulus and the third image after the application of an external stimulus.

Taking a similar example as described above, the interactive security element part of the security means exhibits, prior to the application of an external stimulus, an image in the form of a logo at one first viewing angle and after the security means has been tilted or after the observing unit has changed its viewing position, a picture may be observed at a second viewing angle. Afterwards, some drops of water are applied as an external stimulus, and at the first viewing angle a further logo, which is different from the first one, is revealed.

A third case, wherein prior to the application of an external stimulus a first and a second different image may be observed at a first and a second viewing angle, respectively, and after the application of an external stimulus a third image is revealed which may also be observed at said first viewing angle and a fourth image is revealed which may be observed at said second viewing angle.

Staying with the examples mentioned above, the interactive security element part of the security means exhibits, prior to the application of an external stimulus, an image in the form of a logo at one first viewing angle and after the security means has been tilted or after the observing unit has changed its viewing position, a picture may be observed at a second viewing angle. Afterwards, some drops of water are applied as an external stimulus, and at the first viewing angle a further logo, which is different from the first one, is revealed, and a second picture, which is different from the first one, is revealed at the second viewing angle.

Of course, several external stimuli may be applied to the interactive security element according to the present invention, preferably one after another. To this end, the different embodiments mentioned above are repeated and after the application of the first external stimulus, leading to different images at said first and/or second viewing angle, a second, third, fourth etc. external stimulus is applied to the interactive security element, whereupon further different images are revealed at the first and/or second viewing angles.

Thus, the application of n different external stimuli to the interactive security element according to the present invention leads to the revelation of z images which may be observed at said first viewing angle, wherein n and z are cardinal numbers equal or greater than 1 and are different or equal to each other.

Of course, the application of those n different external stimuli may also lead to different images at said second viewing angle, the number of which shall not be defined here, because it is of minor importance.

The images are not limited to logos and pictures as described for illustration above, but may be of all kinds of objects as defined before.

The volume hologram within the interactive security element according to the present invention is composed of a polymeric support medium having a light diffracting structure therein and exhibiting at least one change or variation in at least one physical property of the polymeric support medium and/or the light diffracting structure when an external stimulus is applied.

In a volume hologram or a volume type phase hologram, a light diffractive structure is usually created by the interference of at least two mutually coherent optical beams of a particular wavelength over the volume of a photosensitive material.

The volume hologram of the present invention may be composed of a polymeric support medium having a photosensitive material disposed therein, the latter being able to create a light diffractive structure throughout the volume hologram when at least two mutually coherent optical beams of a particular wavelength are applied thereto and after any necessary processing.

Therefore, in the simplest way, the volume hologram of the present invention is composed of photosensitive silver halide particles in a polymeric medium, which may be of gelatin. To this end, the grain size of the silver halide particles should be controlled, since too large particles are not useful for the purposes of the present invention. Preferably, the grain size of the silver halide particles is in the range of from 5 to 50 nm, especially of from 10 to 40 nm and most preferably in the range of from 10 to 30 nm. Gelatin is a standard matrix material for supporting photosensitive species, especially silver halide grains. Gelatin can also be photo-cross-linked by chromium (III) ions, between carboxyl groups or gel strands.

Other examples of holographic support media are K-carageenan, starch, agar, agarose, polyvinyl alcohol (PVA), sol-gels (as broadly classified), hydrogels (as broadly classified), and acrylates. Further materials are polysaccharides, proteins and proteinaceous materials, oligonucleotides, RNA, DNA, cellulose, cellulose acetate, polyamides, polyimides and polyacrylamides.

Typical polymers can be selected from polyvinyl alcohol, polyvinyl pyrrolidone, polyhydroxyethyl acrylate, polyhydroxyethyl methacrylate, polystyrenes, functionalised polystyrenens, polyacrylamides, polymethacrylamides, homopolymers or copolymers of polymerisable derivatives of crown ethers, and esters of or co- or terpolymers of polyhydroxyethyl acrylate, polyhydroxyethyl methacrylate, polymethacrylamide or polyacrylamide, optionally with other polymerisable monomers or cross linkers.

In particular, copolymers of, e.g. (meth)acrylamide and/or (meth)acrylate-derived monomers are used, which may be crosslinked. Preferably, hydroxyethyl methacrylate monomer is readily polymerisable and cross-linkable. Polyhydroxyethyl methacrylate is a versatile support material since it is swellable and hydrophilic.

The photosensitive material such as silver halides may be disposed in the support medium by dispersing silver halide grains within a low viscosity precursor of the support medium, followed by either solidification and/or crosslinking of the support medium. Alternatively, a sequential treatment technique can be used, wherein the polymer film is made first and sensitive silver halide particles are added subsequently. These particles are introduced into the support medium by diffusing soluble salts into the polymer matrix where they react to form an insoluble light-sensitive precipitate. The holographic image is then recorded.

Different liquids, such as e.g. water, aqueous solutions of NaNCO₃ or other soluble salts, aqueous solutions of alcohols, such as ethanol or isopropanol; solutions of triethanolamine and solutions of polyethylene glycol, in different concentrations, are able to alter the volume of the support medium, causing its contraction or expansion. Therefore, the holographic image in the volume hologram of the present invention can be recorded after immersing the support medium containing the photosensitive material, e.g. the silver halide particles, in an appropriate liquid, thereby leading to contraction or expansion of the support medium. Additionally, applying different liquids, e.g. those mentioned above, optionally in different concentrations, to different parts of the support medium prior to the recording of the volume hologram may therefore lead to a different response of these parts of the volume hologram to an external stimulus. To this end, in particular multicoloured images of the volume hologram may be obtainable.

The polymer composition may be optimised to obtain a high quality film, suitable for the preparation of a hologram. The film should allow for the production of a uniform matrix, in which holographic fringes can be formed.

If appropriate, the polymeric support medium can also contain pores. Such media are obtainable by formation of the support medium in situ in the presence of a pore-forming agent, e.g. by polymerisation of monomers to a polymer in situ in the presence of a pore forming agent such as gas, liquid, water etc.

The polymeric support medium of the volume hologram need not necessarily contain silver halide particles in order to have a diffractive structure recorded therein.

The polymeric support medium may instead have a polymeric holographic element disposed throughout the volume thereof, wherein the fringes of the holographic element are defined by different degrees of swellability in a liquid.
These different degrees of swellability may correspond to different degrees of polymerisation or cross-linking of the polymeric medium.

Such holograms are produced by a process where in a first step a polymeric matrix is formed, and in the second step, in selected parts of the matrix, a different degree or type of polymerisation is caused, optionally involving a further cross-linking step.

The second step may not of itself form a distinct holographic grating, but a grating will be evident on swelling or contraction of the resultant material.

Thus, the volume hologram of the present invention may comprise at least two polymers distinguished in type or degree of cross-linking (the cross-linking may also be zero). These polymers may be regarded being either “soft” or “hard”, depending on the degree of cross-linking. Either all, some or each of such polymers may include functional groups that are intended to react with an external stimulus.

The holographic fringes, which are relatively lightly cross-linked, are able to swell when being contacted with an appropriate external stimulus, whereas the heavily cross-linked fringes are not. Such swelling may lead to either alteration in the difference of the refractive indices of both polymers or to difference of fringe spacing between that of recording and that of replay.

In case the resulting volume hologram should be responsive to more than one external stimulus, the polymeric support medium may be composed of a layered structure, each layer comprising a different material. Alternatively, the support medium may consist of different materials lying concentrically adjacent to each other throughout their depth.

The polymeric support medium of the volume hologram may also be a so called phase-change polymeric medium, changing for example the degree of opacity/ transparency by changing physical parameters. The temperature and pressure dependant phase-change polymers known in the art may be used.

Other non-silver halide based holographic recording materials which are known in the art may also be used as recording medium, i.e. polymeric support including a recording element, of the present invention. These include photopolymerisable systems as well as photoreactive, photochromic or photorefractive systems that are employed in data storage. Whilst well established as holographic recording materials, these materials have heretofore not been used as materials which are sensitive to external stimuli. Several kinds of such photopolymerisable materials have been used e.g. by companys such as Polaroid or DuPont de Nemours for recording purposes.

Furthermore, gelatin crosslinking by chromium ions has been mentioned before. It is well known that dichromated gelatin has been used in the past as suitable holographic recording material. Thus, it is also applicable for the purpose of the present invention, although the toxicological properties of chromium limit the use of the system and the need to seal the holograms to prevent exposure to moisture will exclude any solution based stimuli. Despite this, holograms which react to physical stimuli such as temperature or pressure will still be possible.

Volume holograms which are usable for the multiple security means of the present invention may be prepared according to the methods described e.g. in WO 95/026499, WO 99/063408, WO 01/050113 or WO 03/087789.

The volume hologram, being part of or constituting the interactive security element of the present invention, is typically thicker than the spacing of the interference fringes within the holographic structure created in the polymeric support medium. The volume hologram has, therefore, a lateral dimension up to some centimetres and a thickness ranging from 5 μm up to a few millimetres, preferably from 5 to 500 μm, more preferably from 5 to 50 μm, and in particular from 6 to 30 μm.

The volume hologram has at least two Bragg layers therein and may include up to some 100 Bragg layers, preferably 5 to 50 Bragg layers, more preferably 5 to 40 Bragg layers, and in particular 5 to 20 Bragg layers. For example, a volume hologram having a thickness of 10 to 20 μm will usually include 5 to 40 Bragg layers.

A Bragg layer is defined as a layer which, after the imprinting process, causes locally restricted changes of the refractive index within the volume hologram when at least two mutually coherent optical beams are interfered and therefore, may be considered as equivalent to an interference fringe. The Bragg layers or interference fringes form a light diffractive structure within the volume hologram.

The volume hologram alters the propagation of the illumination to which it is exposed, but requires precise adjustments for wavelength and direction of the light and media (Bragg selectivity). The Bragg effect does, therefore, mean that the volume hologram will change its optical performance when the spacing between the interference fringes is altered.

The volume hologram within the interactive security element according to the present invention exhibits at least one change or variation in at least one physical property of the polymeric support medium and/or the light diffractive structure when an external stimulus is applied.

Such physical property is one or more of size, shape, density, strength, hardness, hydrophobicity, swellability, integrity, polarizability, charge distribution and combinations thereof.

In this case integrity is meant as the regularity of the structure of the hologram throughout the support medium and modulation depth of the fringes defining the hologram. Such a structure may be destroyed by the action of an external stimulus, e.g. when the external stimulus is a chemical, a solution or dispersion of a chemical, an enzyme or a biological material. In the latter case, the chemical reaction caused by these external stimuli may cleave bonds at specific sites in the polymeric support medium, thus destroying the structure of the hologram. Similarly, the integrity of the polymeric support medium and/or the light diffracting structure may also be destroyed by degradation or re-ordering of the support medium due to a reaction to an external stimulus.

The other terms mentioned above are self explanatory, i.e. size means size of the holographic support medium or size of the light diffractive structure, shape means shape of the holographic support medium or shape of the light diffractive structure, polarizability means polarizablity of components of the holographic support medium or polarizablity of components of the light diffractive structure, charge distribution means charge distribution within the holographic support medium or charge distribution within the light diffractive structure, swellability means solvent swellability of the holographic support medium or solvent swellability of the light diffractive structure etc.

The interaction of at least one of the external stimuli mentioned above with the interactive security element comprising at least one volume hologram according to the present invention causes a chemical or physical reaction within the volume hologram, whereupon one or more of size, shape, density, strength, hardness, hydrophobicity, swellability, integrity, polarizability or charge distribution of the polymeric support medium and/or of the light diffractive structure therein are changed or varied.

In most cases, such changes or variation are caused by alteration of the volume and/or density of the polymeric support medium or of the holographic interference fringes. Additionally or alternatively, molecule shape or molecular order of the polymeric materials may change. Of course, merely parts of the volume hologram (support medium and/or diffractive structure) may be altered by the application of an external stimulus.

Therefore, some parts of the hologram may change and some parts may not change or may change in a different way.
The changes in the physical properties mentioned above cause alterations in the structure of the volume hologram, which lead to at least one change or variation in the reflectance and/or refractance and/or absorbance and/or polarizability of the light diffractive structure which are observable when the volume hologram is illuminated by a light source, e.g. by ambient light, and when an optical detector is used.

In the simplest case, the optical detector is the naked human eye. Other kinds of optical detectors which may be used are described above.

Since the optical properties of a volume hologram are proportional to the refractive indices of the materials of which the volume hologram is composed, changes of the refractive index in the polymeric support medium or in the diffractive structure contained therein, which are caused by an interaction with an external stimulus, may be observed. In a preferred embodiment, the refractive index is changed by swelling or contracting of the support medium and hence of the diffractive structure due to the application of an external stimulus.

In the same way, the reflection, absorption or polarization properties of a material used in the volume hologram according to the present invention may be changed or varied by the influence of an external stimulus. All of these changes or variations cause alterations in the optical performance of the volume hologram of the present invention, which might be observed.

The change or variation in at least one physical property of the polymeric support medium and/or the light diffracting structure may be reversible, partly reversible or irreversible.

The volume hologram being part of or constituting the interactive security element of the present invention is applied to a substrate. Such a substrate may either be the common substrate as described above in the second and fourth embodiment or a substrate layer of a layered structure as described in the third and fourth embodiment.

In order to enhance the visual effect of the volume hologram, an absorbing (i.e. black or dark coloured) and/or reflecting background for the volume hologram on the substrate is preferred. Therefore, the surface of the substrate lying underneath the volume hologram on the side thereof which is not illuminated should preferably exhibit absorbing or reflecting characteristics or a combination of both. In the latter case, of course the support medium as well as the diffractive structure of the hologram should be at least partly transparent.

Preferably, such absorbing and/or reflecting layers are made of materials which are usually used for such purposes in the holographic industry, e.g. layers of metals such as aluminium, dark coloured layers containing absorbing materials such as inorganic or organic pigments, or the like. When such a combination of an absorbing or reflecting background and of a transparent holographic structure is used, the observable changes in the optical behaviour of the volume hologram are very impressive and may be observed easily, even by the naked eye.

The interactive security element being part of the multiple security means of the present invention comprises at least one volume hologram, but may also comprise two or more volume holograms which are interactive to the same external stimulus or to different external stimuli or to the same external stimuli in different sequence.

At least part of the interactive security element of the present invention is in the form of a volume hologram. Alternatively, the security element consists of a volume hologram as described above.

The interactive security element itself may exhibit a form being useful in the known applications of security elements, e.g. may be a label and/or a patch and/or a stripe and/or a thread and /or a window. Of course, a label in addition to a rectangular shape may exhibit any appropriate shape.

Usually, security elements in the form of labels, patches, stripes and/or threads are applied to the surface of a product which has to be secured. In the present invention, the interactive security element being part of the multiple security means is applied onto or into a substrate, which constitutes part of the multiple security means. Methods have been described heretofore.

After the multiple security means of the present invention has been accomplished, the multiple security means may be applied to the surface of a product which has to be secured or constitutes a security product itself.

The multiple security means too, like the interactive security element and the further second security element, may be in the form of a label and/or a patch and/or a stripe and/or a thread.

Therefore, also the multiple security means may be applied to the surface of a product. This might be done by nearly any known process such as by the help of an adhesive, a pressure-sensitive adhesive, a hot-melt adhesive, a reactive or partly reactive hot-melt adhesive or combinations thereof.

Such adhesives are selected so as to ensure that a permanent bond to the surface of the product is achieved. In this way it is possible to avoid the later illicit removal of the multiple security means from the surface of the product. Methods known as tamper evident systems are used to achieve destruction of the multiple security means in the event that illicit removal is attempted. Any adhesives used should also not affect the performance of the multiple security means.

Such processes as well as the materials used as adhesives are very well known in the art and need no further description herein.

The application technology can be a simple thermo-transfer process by using a transparent carrier as a transfer carrier and/or as a release protection foil during the thermo-pressure process. This transparent carrier can be peeled off after the application or can stay on top as a protection layer. In the case of keeping it on top of the security means as a protection layer, usually a good adhesion to the substrate is achieved. The transparent carrier in general exhibits a thickness of some micrometers to some millimetres, especially from 1 μm to 800 μm, preferably from 5 to 300 μm and in particular from 10 to 100 μm. The material thereof is in most cases a temperature stable polyester (e.g. PET) foil.

Such foils can be used in a microperforated version to prevent peeling without damaging of the security means. The microperforation can be done by laserperforation, by mechanically punching or by spark erosion.

When the multiple security means of the present invention is in the form of a stripe or a label, it can be applied in many different designs and application technologies. Furthermore, since such security means which are usually very thin (down to 5 to 50 μm) may be stored on rolls, the application can be done with high quality and with high speed on a substrate.

For example, labels may be conveniently located on a roll which comprises at least one thermostable release layer which is peeled off the security means after application on the surface of the product which is to be secured. By peeling off the release layer of the security means, the surface thereof is free to be exposed to an external stimulus, in particular to the application of humidity, water, chemicals, gases etc. On the other hand, a perforated or porous release layer may be maintained on the security means, since it is able to transmit the external stimuli mentioned above to the volume hologram.

Both versions are advantageously used when the interactive security element is part of the outer surface of the multiple security means of the present invention.

External stimuli like temperature, electrical charge, electrical potential, pressure, magnetism etc. do not need the release layer to be peeled off, since usually it is very thin and does not negatively influence the changes within the holographic structure caused by these stimuli. In the latter case, the release layer may act as a protective layer on the security means. This version is advantageously used, when the interactive security element is located within the layer or within a layer of the layered system of the security means, thereby having no direct contact to one of the outer surfaces of the security means.

In general, security means exhibiting such a protective layer, either porous or not, provide very good protection against abrasion and scratching. Since, on the other hand, such protective layers bearing microperforations may also prevent the peeling of the protective layer without damaging the security means itself (so called tamper evident self-destruction behaviour), security means of the present invention which exhibit protective layers are preferred. Of course, these protective layers must be thin and flexible enough to allow volume changes in the volume hologram structure within the interactive security element.

As mentioned above, the security means of the present invention may be composed of a layered structure itself, but it may also be integrated into a security product of the laminate type or of the injection-mould type, i.e. inside such a product.

The lamination process has to be executed under a strict temperature control in order to avoid destruction of the volume hologram within the interactive security element, or, especially when polycarbonate polymers are used, avoid the yellowing tendency of these polymers when being laminated at temperatures of about 200° C. over a longer period. Such yellowing is especially harmful when security documents are produced which should have a life-time guarantee of at least 10 years, e.g. ID-cards, driver-licenses, passports etc.

When the security means of the present invention is integrated in a laminated or injection moulded security product, external stimuli like temperature, electrical charge, electrical potential, pressure, magnetism etc. may be applied to the security means and cause a change within the volume hologram within the interactive security element thereof as long as at least one of the layers or protective layers one either one or both sides of the security means is thin and flexible enough in order to allow volume changes in the interactive security element.

When, on the other hand, external stimuli like humidity, water, chemicals, gases etc. shall be applied, at least one of the layers on each side of the security means within the security product must allow a permeability of the external stimulus to the volume hologram within the interactive security element in order to cause there at least one change in the physical properties thereof, which is observable by optical changes of the volume hologram. This permeability may be achieved by at least one of a transparent carrier with a perforation therein, especially in the form of microholes or a substrate having lateral or horizontal channels therein. Such microholes may be produced by laser beams at a very high speed, e.g. by CO2-lasers, Nd:YAG lasers and UV-lasers at different wavelength or by spark erosion. Such microholes may exhibit high aspect ratios or may have a conical form whichever is more appropriate.

Similarly, also the above mentioned channels in substrates may be produced mechanically.

Preferably, the volume hologram constituting whole or part of the interactive security element of the multiple security means of the present invention is covered with a substantially transparent overlay structure, which is in particular porous. Of course, a non porous overlay structure may also be used, when the substrate itself is permeable to the external stimulus applied.

When applied in a window structure, the multiple security means of the present invention can be covered on either one or both sides thereof with a protective layer. At least one of these layers must be permeable (e.g. porous) to the external stimulus applied thereto, at least at the part of the multiple security means where the interactive security element is located. Thus, also the embodiment where the security means is covered at only one side with a protective layer is preferred when humidity, water, chemicals, chemical solutions, gases etc. are used as external stimuli.

The multiple security means of the present invention is preferably used for verification and/or authentication and/or anti-counterfeiting purposes, and in particular it is used for the verification and/or authentication and/or anti-counterfeiting of a product.

Therefore, products which are containing a multiple security means according to the present invention are included within its scope too.

Those products which may be provided with the multiple security means according to the present invention are in particular security products such as banknotes, passports, identification documents, smart cards, driving licenses, share certificates, bonds, cheques, cheque cards, tax banderols, postage stamps, tickets, credit cards, debit cards, telephone cards, lottery tickets and gift vouchers, but also packing materials, decorative materials, brand products or any other product which has to be secured, e.g. household appliances, spare parts, shoes, clothes, pharmaceuticals, cosmetics, sporting goods, computer hard- and software, spirits, cigarettes, tobacco and the like.

These products may be provided with one or more security means according to the present invention, which may show similar or different security effects including similar or different optical effects and whose volume holograms included are responsive to one or more external stimuli of the same or different kind.

Therefore, when the security means of the present invention is used, a high security level may be achieved, since it is easily possible to combine public features which are very easy to handle with features which might merely be recognised and verified by people skilled in the art, even within one single security means.

Since the reaction time of the interactive security element of the present invention to an external stimulus applied is very short, the verification thereof may be executed within a very short period of time. As described before, the reaction time is within a period of one tenth of a second up to several seconds, in particular from 0.1 to 10 seconds. Thus, the verification may be executed in a time period of some tenth seconds and should not be longer than a minute, depending on the numbers of external stimuli applied. Of course, more than two external stimuli may result in a slightly longer time for the verification of the interactive security element.

The verification takes place using a light source, which is usually daylight, ambient light, white light, light being composed of one or more specific wavelength, coherent light, pulsed light or modulated light.

The multiple security means of the present invention is the first example of a security means containing an interactive security element, where the interactivity is due to a volume hologram which is responsive to an external stimulus, ever known. Such an interactive security element is combined with a further security feature which may be a commonly used security feature regarding the particular security product. Thus, a security feature known and accepted in the market may be used in combination with a novel and striking new feature. Although the latter is relatively easy to produce at low cost, it imparts a very high security level to the products which are provided therewith. The interactive security element is virtually impossible to copy, due to the complexity of the volume hologram and the component parts, as well as due to the difficulty of the method of creating the holographic images by use of coherent beams.

Furthermore, external stimuli creating optical effects which are easily visible to the naked eye may be combined with further external stimuli causing optical effects which may only be recognised by persons skilled in the art being in possession of the equipment needed, thereby enhancing the security level to an even greater extent.

Still furthermore, the interactive security element of the present invention exhibits outstanding optical effects which might be easily recognised by the so called “person in the street”, even with the naked eye and without having an original specimen for comparison in hand. Therefore, the embodiment where at least one of the interactive security feature and the further second security feature is detectable by the naked eye or by the naked eye assisted by the optical detectors mentioned above is preferred. Said outstanding optical effects of the interactive security element may be completed, enlarged or even enhanced by adding the further second security element to achieve at the multiple security means of the present invention.

Therefore, the multiple security means of the present invention is an outstanding means for imparting an extreme barrier to counterfeiting and copying and an associated very high security level to products, and in particular to all types of security products.

The following examples are provided for illustrating the present invention and shall not be construed as limitative to the remainder of the disclosure in any way whatsoever.

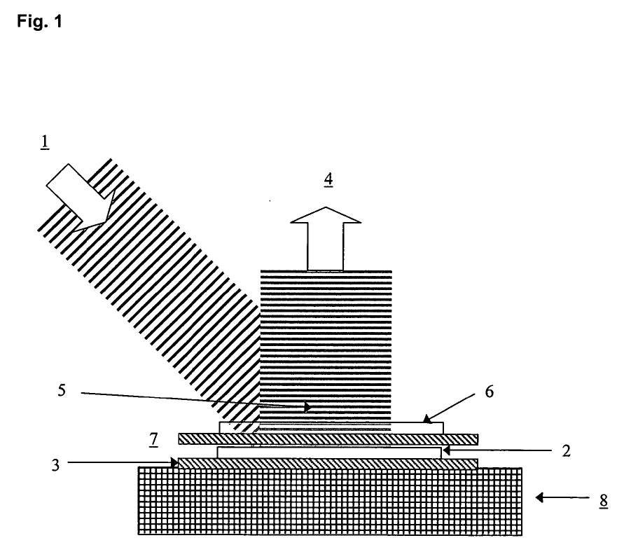

At first, the preparation of a volume hologram out of a reflective contact master hologram in general is explained, which is illustrated by FIG. 1.

A master hologram displaying a left/right switch, such that a first image is visible when the hologram is tilted to the left and a second image when the hologram is tilted to the right, is made by standard mastering techniques well known to the skilled technician. The emulsion layer (2) of the master hologram is typically supported on a glass substrate (3) with the whole set up on a metal plate or an optical bench (8). When laser light (1) of a particular wavelength is incident upon the emulsion layer (2) of the master hologram, at least some of this incident light (4) is reflected by the fringe microstructure within the hologram layer, and produces a standing wave of interference (5) in the space where the coherent incident and reflected light coincide. When a second hologram recording medium, comprising a photosensitive layer (6) of the appropriate spectral sensitivity, which is typically located upon a PET or triacetate carrier film (7) is supported in a stable position in contact or slightly displaced from the surface of the master hologram, the interference between the incident and reflected waves is recorded in the photosensitive layer of the second hologram recording medium. This recording is capable of reconstructing predominantly the same image as was seen in the master hologram, whereby some minor positional difference dependent upon the spacing of the second hologram layer and the master hologram may occur.

### EXAMPLE 1

Two reflective master holograms are produced, using the standard methods known by the person skilled in the art. The first master hologram, displaying a left/right switch as explained above, reveals a first image in the form of a MERCK-logo when tilted to the left and a second image in the form of the wording “hologram” when tilted to the right. The second master hologram, also displaying a left/right switch, reveals a first image in the form of the word “valid” when tilted to the left and a second image in the form of the word “secure” when tilted to the right.

As a recording medium for producing a volume hologram being responsive to at least one external stimulus, a silver halide holographic film is used, being composed of a gelatin film containing fine silver halide grains having a grain size of about 10-20 nm which has been coated in a dry thickness of about 10 μm on a triacetylcellulose base being of a thickness of about 200 μm. The gelatin emulsion as such can be prepared following standard methods such as those outlined in e.g. H. I. Bjelkhagen, Silver halide recording materials, Springer-Verlag, Berlin 1993, and can then be coated onto a suitable PET or triacetate substrate.

The silver halide holographic film mentioned above is positioned on top of the first master hologram and the whole set is exposed to red laser light, for example a 633 HeNe laser, in a standard contact copying set up, such that the appropriate stability is organised for the whole system during the exposure (according to FIG. 1). Then, the contact copy film is removed and kept in a dark place prior to the second exposure.

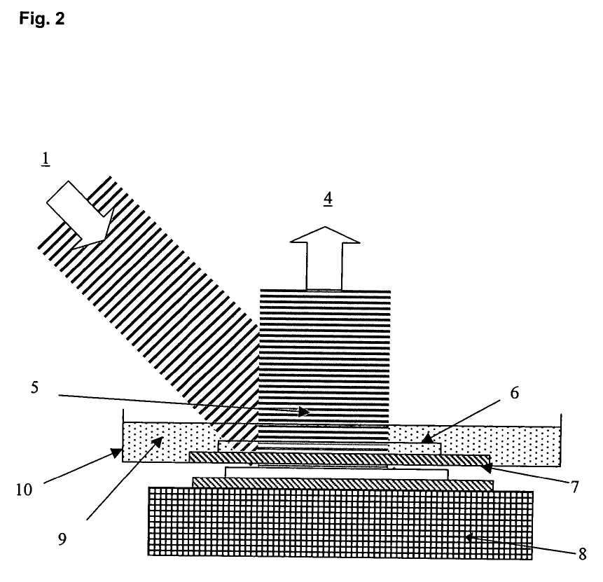

The second master hologram is then placed in the copying rig. An optically transparent shallow, water (9) filled dish (10) is placed on top of the second master hologram and the previously exposed contact copy film containing a latent image of the first's master content is then placed recording side up in the dish in such 1550 Xiaer that the images from the first exposure will be in registration with those from the second. After allowing time for the recording material to expand under the influence of water, the set up is exposed to laser light for a suitable time. The characteristics of the second recording are illustrated by FIG. 2. All integers identical to those used in FIG. 1 indicate the same features as in FIG. 1.

The contact copy film is then removed and developed and bleached in a standard manner. This might be done e.g. by developing in a low solvent developer such as D19b of Kodak or in CW-C2 of Fuji Film, bleaching in a solution such as ferric sulphate or ferric EDTA, followed by washing, usually with water, and drying. Thereby, a first volume hologram being responsive to water as an external stimulus is achieved.

The resulting holographic film, when exposed to normal white light, will display the MERCK-logo when tilted to the left at a first viewing angle and the wording “hologram” when tilted to the right at a second viewing angle, when being dry, under observation with the naked eye.

After immersing the holographic film in water (or after wetting the surface of the holographic film with water), the first two images will disappear. Instead, a third image being in the form of the wording “valid” will be seen when the hologram is tilted to the left at a viewing angle which is nearly identical to the first viewing angle and the wording “secure” will be seen when the hologram is tilted to the right at a viewing angle which is nearly identical to the second viewing angle.

In order to produce a second type of a volume hologram being responsive to water as an external stimulus, an aqueous solution of gelatin, containing 15% by weight of gelatin, is coated on a subbed PET film to a dry thickness of approximately 250 μm. The coating is hardenend for 3 minutes in a 1% (by weight) glutaraldehyde solution. The film is first soaked in a 0.3M silver nitrate solution. After soaking the film, the surface solution is wiped off and the film is finally dried under hot air. Afterwards, the film is soaked in a solution of 3% (by weight) lithium bromide and 0.05% (by weight) ascorbic acid containing a methanolic solution of pinacyanol dye. The film is then washed with deionised water and sensitised by agitation in a solution of 5% (by weight) sodium ascorbate for 20 seconds, rinsed and dried (the production scheme disclosed in J. Blyth et. al., Imaging Science Journal, 1999,47(2), pages 87-91, may be followed).

The resulting film is used to make a holographic contact copy, using the process according to step 2 mentioned in example 1 above, which is illustrated by FIG. 2. As a master hologram, the second master hologram mentioned above is used.

After the exposure to a red HeNe (633 nm) laser light and the following developing, bleaching and washing procedure, the resulting hologram is dried.

The resulting second holographic film, when exposed to normal white light, will display no image when tilted to the left at a first viewing angle and no image when tilted to the right at a second viewing angle, when being dry and being observed with the naked eye.

After immersing the holographic film in water (or after wetting the surface of the holographic film with water), a first image being in the form of the wording “valid” will be seen when the hologram is tilted to the left at a viewing angle which is nearly identical to the first viewing angle and a second image in the form of the wording “secure” will be seen when the hologram is tilted to the right at a viewing angle which is nearly identical to the second viewing angle.

Patches having a size of about 2 cm×2 cm each are made from the first and second holographic films, respectively, made according to the procedures explained above.

A polymeric substrate, made of polycarbonate, as usually used in the production of ID cards, is provided with the patches made of the first and second holographic films mentioned above by application by means of an appropriate adhesive, both patches being located adjacent to each other on the same surface of the substrate.

The dry polymeric substrate provided with the patches, when exposed to normal white light, will display the MERCK-logo when tilted to the left at a first viewing angle and the wording “hologram” when tilted to the right at a second viewing angle, under observation with the naked eye at the place where the patch made of the first holographic film is located. At the place where the patch made of the second holographic film is located, no image can be observed with the naked eye.

After wetting the surface of the patches with water, the first two images at the first patch will disappear. Instead, a third image being in the form of the wording “valid” will be seen when the hologram is tilted to the left at a viewing angle which is nearly identical to the first viewing angle and the wording “secure” will be seen when the hologram is tilted to the right at a viewing angle which is nearly identical to the second viewing angle, with the proviso, that both words may be observed at the first patch as well as at the second patch.

Depending on the range of laser sensitivity of the holographic recording film and on the type and number of colour forming compounds in the gelatin base thereof, the volume hologram prepared according to the method explained above may exhibit coloured images, being of the same or of different colours. To this end, the recording of the first and of the second step can be done with equal or different types of lasers. Additionally, all images can be recorded in a 3-dimensional manner. The example using the different wordings has been used for the simplicity of explanation only.

### EXAMPLE 2

A self-adhesive brand protection label comprising a paper sheet containing green fluorescent fibers in the paper mass which may be activated using UV-light, is provided with a printed image in the form of a number code, being made of a printing ink containing colour-shifting pigments (Securalic® Blue-Lilac from Merck KGaA, Darmstadt), which change their reflective colour from blue to lilac depending on the viewing angle, printed on a dark background.

A patch made of the first holographic film mentioned in example 1 is applied to the surface of the self-adhesive brand protection label by means of an appropriate adhesive in such a way that the printed image and the patch do not overlap. The self-adhesive brand protection label is then applied to a pharmaceutical package.

When observed by a person on the street using the naked eye, the self-adhesive brand protection label on the pharmaceutical package reveals an optically variable feature in the form of the printed image (number code) exhibiting two different colours (blue/lilac) depending on the viewing angle. Furthermore, at the place where the patch carrying the interactive security element of the present invention described in example 1 is located, the MERCK-logo as well as the wording “hologram” can be observed when the pharmaceutical package is tilted to the left and right side, respectively. When the surface of the patch is wetted by water, the wording of the logos changes into “valid” by tilting the pharmaceutical package to the left and into “secure” by tilting the pharmaceutical package to the right.

Still furthermore, when the self-adhesive brand protection label on the pharmaceutical package is checked in, for example, a pharmacy and is illuminated by UV light, the green fluorescent fibers in the paper mass may be revealed.

Thus, a high variability of security features on the pharmaceutical package may be achieved, including an interactive response to an external stimulus being as easily available as water.

Of course, several further combinations of different types of security features are possible, according to the description above. The present examples have been chosen for the sake of simplicity of explanation only.

1. A security device comprising:
at least one interactive security element; and
at least one further second security element, the interactive security clement comprises al least one volume hologram, that is responsive to at least one applied external stimulus and exhibits at least one defined optical effect in the form of an image, in response to the application of the at least one external stimulus to the volume hologram, the interactive security clement and the at least one further second security clement being applied to at least one substrate.

2. (canceled)

3. The security device according to claim 1, wherein the interactive security clement and the further second security clement are applied to the at least one substrate in a spaced apart manner, adjacent or partially overlapping or totally overlapping manner, or one on top of the other.

4. (canceled)

5. (canceled)

6. The security device according to claim 3, wherein the interactive security element and the further second security element are applied to different substrate layers, the interactive security element and the further second security element being located apart from each other or adjacent to each other or partly or totally overlapping each other when the security means device is virtually viewed from either one of the top and bottom surface thereof.

7. (canceled)

8. The security device according to claim 1, wherein the interactive security element and the further second security clement interact with each other.

9. (canceled)

10. The security device according to claim 1, wherein the at least one optical effect exhibited by the volume hologram in the form of a first image may be observed by using an optical detector at a first viewing angle and wherein a second image which is different from the first image may be observed using an optical detector at a second viewing angle which is different from the first viewing angle, the first and second images observed at the first viewing angle and the second viewing angle, respectively, are different in colour and/or intensity and/or brightness and/or object and/or position and/or orientation and/or size and/or perspective and/or parallax and/or apparent depth.

11. The security device according to claim 10, further comprising one or more additional further images that may be observed at one or more further viewing angles being different from the first and second viewing angles, the first and second images and the one or more additional further images are different in colour and/or intensity and/or brightness and/or object and/or position and/or orientation and/or size and/or perspective and/or parallax and/or apparent depth.

12. (canceled)

13. The security device according to claim 1, wherein at least one of humidity, water, gases, vapours, organic solvents, chemicals, solutions or dispersions of chemicals, pressure, temperature, light of particular wavelengths, magnetism, electrical field, electrical charge, electrical potential, non-ionising radiation, electromagnetic radiation, radioactive radiation, enzymes, biological materials and combinations of two or more thereof, optionally varying in degree or intensity, is applied as the external stimulus.

14. The security device according to claim 1, wherein the volume hologram is composed of a polymeric support medium having a light diffractivc structure embedded therein and exhibiting al least one change or variation in at least one physical property of the polymeric support medium and/or the light diffractivc structure when the external stimulus is applied.

15. The security device according to claim 14, wherein the physical properly is one or more of size, shape, density, strength, hardness, hydrophobicity, swellability, integrity, polarizability, charge distribution and combinations thereof.

16. The security device according to claim 1, wherein the further second security clement is disposed throughout the whole volume or part thereof of the volume hologram.

17. The security device according to claim 1, wherein the further second security clement is one or more of planchettes, fibers, fluorescein particles or fibers. HI or UV active colorants, magnetic particles, electrically conductive particles, optically variable pigments, LCP pigments, DNA- and/or Bio-coding materials, organic or inorganic taggants, laser engravings, etc water marks, and chemical additives which are observable by irradiation with light of particular wavelengths or by chemical reaction or by manipulation of the at least one substrate.

18. The security device according to claim 1, wherein the further second security element is disposed throughout the whole volume or a part thereof of the at least one substrate.

19. (canceled)

20. The security device according to claim 1, wherein the further second security element is applied onto and/or into the at least on substrate in the form of a printing and/or an optical system and/or a label and/or a patch and/or a stripe and/or a thread and/or a window.

21. The security device according to claim 20, wherein the further second security clement is one or more of a hologram, a kinegram, a laser engraving, an RFID element, an optically variable printing and/or an optically variable system of optically variable pigments, optically variable thin film structure and/or liquid crystal polymers, a microtext, guilloches, a magnetic feature, an electrically conductive feature, an 1R or UV active feature, a photoluminescent feature, an electroluminescent feature, a photochromic feature, a thermochromic feature, a hydrochromic feature, a tribochromic feature, a piezochromic feature, a DNA- and/or Bio-coding feature, etc.

22. The security device according to claim 1, wherein the interactive security element is applied to the at least one substrate in form of a label and/or a patch and/or a stripe and/or a thread and/or a window.

23. The security device according to claim 1, wherein the at least one of the interactive security element and the further second security element is detectable by the unassisted naked eye, or the naked eye assisted by spectacles, magnifying lenses, microscopes, lenticular lenses, polarizing filters, diffractive structures, wavelength filter elements or light enhancing systems, spectrophotometers, spectrum analyzers, CCD-sensors, CMOS-sensors, OCR-readers, bar code readers, cameras or image recognisers.

24. (canceled)

25. Use of the security device according to any one or claim 1 for verification and/or identification and/or authentication and/or anti-counterfeiting purposes.

26. Use of the security means device according to claim 25 for the verification and/or identification and/or authentication and/or anti-counterfeiting of a product.

27. A product, containing the security device according to claim 1.

28. The product according to claim 27, which is a banknote, a passport, an identification document, a smart card, a driving license, a share certificate, a bond, a cheque, a cheque card, a tax banderol, a postage stamp, a ticket, a credit card, a debit card, a telephone card, a lottery ticket, a gift voucher, a packing material, a decorative material, a brand product or any other product which has to be secured.

29. The security device according to claim 18, wherein the interactive security element and the further second security element are disposed throughout different substrate layers.
